(19) United States
(12) Patent Application Publication
(10) Pub. No.: US 2022/0371804 A1
(43) Pub. Date: Nov. 24, 2022

(54) FIBER-BASED COMPOSITE MATERIAL FOR PADDING FOR MAILERS

(71) Applicant: Georgia-Pacific Corrugated LLC, Atlanta, GA (US)

(72) Inventors: Andrew Geoffrey Halcomb, Peachtree Corners, GA (US); Michael Todd Payne, Atlanta, GA (US)

(21) Appl. No.: 17/743,763

(22) Filed: May 13, 2022

Related U.S. Application Data
(60) Provisional application No. 63/191,358, filed on May 21, 2021.

(51) Int. Cl. B65D 81/03; B31B 70/62

(52) U.S. Cl. CPC B65D 81/03; B31B 70/62; B31B 2170/20

(57) ABSTRACT

Fiber-based composite material for padded mailers and corresponding systems and methods are provided herein. A fiber-based composite includes a fiber-based backing material and a fiber-based padding attached to the backing material to provide cushioning for items within a mailer. The fiber-based padding is applied as a plurality of tubular structures, each defining a perimeter extending from a first point of attachment to a second point of attachment. The perimeter further defines an apex point which is spaced apart both laterally and vertically from a center point on the backing material that is between the first and second points of attachment. A plane connecting the center point and the apex point defines an angle with the backing material that is greater than 5 degrees and less than 75 degrees.

### CROSS-REFERENCE TO RELATED APPLICATION(S)

This application claims priority to U.S. Provisional Application No. 63/191,358, filed May 21, 2021, entitled “Fiber-Based Composite Material for Padding for Mailers”, the contents of which is hereby incorporated by reference herein in its entirety.

### BACKGROUND OF THE INVENTION

There is an increased demand for delivery of items, such as directly to an end user's home or office. Further, the increased efficiency in the logistics of performing delivery has also driven up delivery capabilities. As such, there is an increased desire for the packaging to be environmentally friendly, while protecting the items within the delivered packaging.

Padded mailers are one such form of packaging option. Some examples of padded mailers include two panels that attach on at least three sides to create a pocket for holding an item (e.g., document, blister pack, batteries, retail product, etc.). Some padded mailers can be formed around the item for shipping and delivery. Other example padded mailers are formed with an open pocket (such as by attaching three sides and leaving the fourth side open). Once such a padded mailer is formed, the item can be placed inside and the fourth side can be sealed—often by folding over a flap on one of the panels and sealing it to the other panel. Additional features, such as tear strips or pull-strip adhesive can be provided on the padded mailer for ease of packaging and/or opening. Some padded mailers form the paneling or other portions from plastic or other material that is non-recyclable.

Padded mailers, notably, also include padding, such as within internal pouches in one or more of the panels to provide cushioning and protection for the item inside the pocket. Unfortunately, many padded mailers are formed using plastic for the padding, such as via air cells or other technology. Such plastic, as noted above, however is typically non-recyclable. As such, there is a desire to form a more easily recyclable padded mailer.

### BRIEF SUMMARY OF THE INVENTION

Some embodiments of the present invention form a recyclable padded material. In this regard, the padding may be formed utilizing a fiber-based material and attached to a backing material. The fiber-based material may be adhered to the backing with a recyclable adhesive. Notably, the corresponding padded mailer may, in some embodiments, be able to be introduced into the generally available curbside recycling stream.

In some embodiments, the padding may be formed by a plurality of tubular structures, oriented in the same direction (e.g., the tubular structures are parallel). The tubular structures may have a sinusoidal cross-sectional shape when applied and may go through a forming or crushing process, where a force is applied resulting in the tubular structures having a non-sinusoidal cross-sectional shape. Alternatively, in some embodiments, the tubular structures may be formed into the non-sinusoidal cross-sectional shape during application to the backing material. Once the padding is formed, the composite material can be formed into mailers, wound into a roll for later use, or the like.

The non-sinusoidal cross-sectional shape of the tubular structures is designed to provide desirable protection for various items placed within the mailer, such as by providing localized shock absorption. The shock absorption can be modified, for example, by modifying the fiber-based material and/or the size and shape of the cross-sections of the tubular structures. Depending on the desired padded protection, the tubular structures may form different non-sinusoidal cross-sectional shapes. For example, during formation, a force could be applied in a non-perpendicular direction to cause crushing at an angle with respect to vertical. The resulting tubular structures may lean to one side, which may provide desirable padded protection.

In comparison to corrugate, which includes fluting having a sinusoidal cross-sectional shape positioned between a top liner and a bottom liner, embodiments of the present invention lack a secondary top liner such that the tubular structures may be exposed directly the item(s) to be padded. This beneficially affords localized shock absorption (e.g., individual tubular structures may provide padding independently of other tubular structures), as the top liner would otherwise cause forces to spread out across the liner and, thus, maintain rigidity. The present invention affords a more flexible, lighter padding, which is more cost effective to manufacture.

In some embodiments, such padded protection may be particularly beneficial for relatively lighter items, e.g., having a weight of 10 lbs. or less. Likewise, such items may be smaller and designed to fit inside the pouch of some padded mailers (e.g., padded mailers with surface area of ˜5 sq. ft or less). Notably, however, embodiments of the present invention are designed to work with any suitable size padded delivery or storage option and any suitable weight range of item stored therein. For example, the composite material may be used for padding at the bottom of a container (e.g., the bottom of a watermelon carton).

As noted above, the padding is easily recyclable, since the material uses recyclable papers, and, in some cases, a recyclable adhesive. Notably, the padded mailer could be pre-made (such as at a manufacturing facility) or could be formed at the customer site (e.g., where the article meant for mailing within the padded mailer is supplied). Further, the composite material may also work with automated machines that form the padded mailer around the item (e.g., as opposed to being hand-packed into a pouch).

In an example embodiment, a fiber-based composite material is provided. The fiber-based composite material comprises a fiber-based backing material; and a fiber-based padding attached to the backing material for providing cushioning, wherein the padding comprises a plurality of tubular structures, wherein each of the plurality of tubular structures defines a longitudinal axis extending along the backing material. Each of the plurality of tubular structures defines a cross-section in a cross-sectional plane perpendicular to the longitudinal axis. The cross-section defines a perimeter extending from a first point of attachment to the backing material to a second point of attachment to the backing material. The perimeter includes an apex point. In the cross-sectional plane, the apex point is spaced apart both laterally and vertically from a center point on the backing material that is positioned between the first point of attachment and the second point of attachment and along the longitudinal axis, such that a plane extending along the longitudinal axis and connecting the center point and the apex point defines an angle with the backing material that is greater than 5 degrees and less than 75 degrees.

In some embodiments, the apex point along the perimeter is a point along a fold in the tubular structure.

In some embodiments, a first portion of the perimeter extends away from the backing material from the first point of attachment to the apex point along the perimeter. A second portion of the perimeter extends back toward the backing material from the apex point to the second point of attachment. In some embodiments, the apex point is laterally further away from the center point than the second point of attachment is away from the center point, and the apex point is laterally closer to the second point of attachment than to the first point of attachment. In some embodiments, the first portion of the perimeter extends away from the first point of attachment in a first direction that is laterally toward the center point, and the second portion of the perimeter extends away from the second point of attachment in a second direction that is laterally away from the center point.

In some embodiments, the angle between the backing material and the plane connecting the center point and the apex point is between 10 degrees and 60 degrees.

In some embodiments, the plurality of tubular structures are attached to the backing material in parallel relation to each other.

In some embodiments, each of the plurality of tubular structures define an uncrushed state and a crushed state, wherein each of the plurality of tubular structures enter the crushed state from the uncrushed state via application of a crushing force that occurs after the plurality of tubular structures are attached to the backing material. The application of the crushing force is in a non-perpendicular direction with respect to the backing material.

In some embodiments, each of the plurality of tubular structures define an uncrushed state and a crushed state, wherein each of the plurality of tubular structures enter the crushed state from the uncrushed state via application of a crushing force that occurs after the plurality of tubular structures are attached to the backing material. The application of the crushing force is in a perpendicular direction with respect to the backing material.

In some embodiments, the plurality of tubular structures were formed into a crushed state during attachment to the backing material.

In some embodiments, the plurality of tubular structures are formed from a continuous web of fiber-based material.

In some embodiments, each of the plurality of tubular structures is formed from a distinct portion of fiber-based material.

In some embodiments, the fiber-based composite material further defines a shape that is formable into the mailer defining a pouch for receiving the one or more items therein, wherein the padding is positioned along the shape such that the padding forms an internal surface of the pouch so as to provide padded protection for the one or more items when the one or more items are located in the pouch.

In some embodiments, the fiber-based composite material is formed into a roll.

In some embodiments, the fiber-based padding is attached to the backing material using a recyclable adhesive.

In another example embodiment, a mailer formed from a fiber-based composite material is provided. The fiber-based composite material comprises a fiber-based backing material and a fiber-based padding attached to the backing material for providing cushioning to one or more items within the mailer. The padding comprises a plurality of tubular structures, wherein each of the plurality of tubular structures defines a longitudinal axis extending along the backing material. Each of the plurality of tubular structures defines a cross-section in a cross-sectional plane perpendicular to the longitudinal axis. The cross-section defines a perimeter extending from a first point of attachment to the backing material to a second point of attachment to the backing material. The perimeter includes an apex point. In the cross-sectional plane, the apex point is spaced apart both laterally and vertically from a center point on the backing material that is positioned between the first point of attachment and the second point of attachment and along the longitudinal axis, such that a plane extending along the longitudinal axis and connecting the center point and the apex point defines an angle with the backing material that is greater than 5 degrees and less than 75 degrees.

In some embodiments, the mailer further comprises a pouch for receiving the one or more items therein, wherein the padding forms an internal surface of the pouch so as to provide padded protection for the one or more items when the one or more items are located in the pouch.

In some embodiments, the mailer is formed with the fiber-based material using a recyclable adhesive.

In yet another example embodiment, a method for forming a mailer is provided. The method comprises providing a fiber-based composite material comprising a fiber-based backing material and a fiber-based padding attached to the backing material for providing cushioning to one or more items within the mailer. The padding comprises a plurality of tubular structures, wherein each of the plurality of tubular structures defines a longitudinal axis extending along the backing material. Each of the plurality of tubular structures defines a cross-section in a cross-sectional plane perpendicular to the longitudinal axis. The cross-section defines a perimeter extending from a first point of attachment to the backing material to a second point of attachment to the backing material. The perimeter includes an apex point. In the cross-sectional plane, the apex point is spaced apart both laterally and vertically from a center point on the backing material that is positioned between the first point of attachment and the second point of attachment and along the longitudinal axis, such that a plane extending along the longitudinal axis and connecting the center point and the apex point defines an angle with the backing material that is greater than 5 degrees and less than 75 degrees. The method further includes forming the mailer using the fiber-based composite material.

In some embodiments, the method further includes forming a pouch in the mailer for receiving the one or more items therein, wherein the pouch is formed such that the padding forms an internal surface of the pouch so as to provide padded protection for the one or more items when the one or more items are located in the pouch.

In some embodiments, each of the plurality of tubular structures define an uncrushed state and a crushed state, wherein each of the plurality of tubular structures is in the crushed state when the apex point is spaced apart both laterally and vertically from the center point on the backing material. The method further comprises crushing the fiber-based composite material to cause each of the plurality of tubular structures to form the crushed state by applying a force in a non-perpendicular direction with respect to the backing material.

In yet another example embodiment, a fiber-based composite material for providing cushioning formed by a process is provided. The process comprises attaching a fiber-based padding to a fiber-based backing material, wherein the padding is formed of a plurality of tubular structures, and wherein each of the plurality of tubular structures defines a longitudinal axis extending along the backing material. The process further includes applying a crushing force onto the fiber-based padding to cause each of the plurality of tubular structures to form a crushed state from an uncrushed state. When in the crushed state, each of the plurality of tubular structures defines a crushed state cross-sectional profile that includes a crushed state apex point. When in the uncrushed state, each of the plurality of tubular structures defines an uncrushed state cross-sectional profile that includes an uncrushed state apex point. The crushed state apex point is closer to the backing material than the uncrushed state apex point.

In some embodiments, applying the crushing force onto the fiber-based padding comprises applying the crushing force in a perpendicular direction with respect to the backing material.

In some embodiments, applying the crushing force onto the fiber-based padding comprises applying the crushing force in a non-perpendicular direction with respect to the backing material.

In yet another example embodiment, a mailer comprises a first panel defining a top edge, a bottom edge, and two-opposing side edges. The mailer further includes a second panel defining a top edge, a bottom edge, and two-opposing side edges. The second panel is attached the first panel to define a pouch therebetween. The first panel further defines a padding section that forms a first internal surface of the pouch. The second panel further defines a padding section that forms a second internal surface of the pouch. The first panel comprises a composite material for the padding section, wherein the composite material comprises a fiber-based backing material and a fiber-based padding attached to the backing material for providing cushioning to one or more items within the mailer. The padding comprises a plurality of tubular structures, wherein each of the plurality of tubular structures defines a longitudinal axis extending along the backing material. Each of the plurality of tubular structures have been crushed from an uncrushed state into a crushed state. When in the crushed state, each of the plurality of tubular structures defines a crushed state cross-sectional profile that includes a crushed state apex point. When in the uncrushed state, each of the plurality of tubular structures defines an uncrushed state cross-sectional profile that includes an uncrushed state apex point. The crushed state apex point is closer to the backing material than the uncrushed state apex point.

In some embodiments, each of the plurality of tubular structures have been crushed from the uncrushed state into the crushed state via a crushing force applied in a perpendicular direction with respect to the backing material.

In some embodiments, each of the plurality of tubular structures have been crushed from the uncrushed state into the crushed state via a crushing force applied in a non-perpendicular direction with respect to the backing material.

In yet another example embodiment, a fiber-based composite material is provided. The fiber-based composite material comprises a fiber-based backing material; and a fiber-based padding attached to the backing material for providing cushioning. The padding comprises a plurality of tubular structures. Each of the plurality of tubular structures defines a longitudinal axis extending along the backing material. Each of the plurality of tubular structures define a cross-section in a cross-sectional plane perpendicular to the longitudinal axis. The cross-section defines a perimeter extending from a first point of attachment to the backing material to a second point of attachment to the backing material. The perimeter is a portion of a non-sinusoidal cross-sectional shape of a cross-section of the padding within the cross-sectional plane.

In some embodiments, the perimeter further includes an apex point spaced apart both laterally and vertically from a center point on the backing material that is along the longitudinal axis and between the first point of attachment and the second point of attachment, such that a plane extending along the longitudinal axis and connecting the center point and the apex point defines an angle with the backing material that is greater than 5 degrees and less than 75 degrees.

In some embodiments, the perimeter is further defined by a first portion consisting of a first concave segment starting at the first point of attachment connected to a first convex segment and a second portion consisting of a second concave segment starting at the second point of attachment continuing into a second convex segment, wherein the first convex segment and the second convex segment meet at a midpoint of the perimeter.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A shows a top view of an example composite material with an example backing material and a fiber-based padding defining a sinusoidal cross-sectional shape, in accordance with some embodiments discussed herein;

FIG. 1B illustrates a cross-sectional view of the example composite material with an example backing material and fiber-based padding shown in FIG. 1A taken along line 1-1, in accordance with some embodiments discussed herein;

FIG. 2A illustrates a top perspective view of an example composite material with an example backing material and a fiber-based padding defining a first non-sinusoidal cross-sectional shape, in accordance with some embodiments discussed herein;

FIG. 2B illustrates a cross-sectional view of the example composite material with the example backing material and fiber-based padding shown in FIG. 2A taken along line 2-2, in accordance with some embodiments discussed herein;

FIG. 3A illustrates a top perspective view of an example composite material with an example backing material and a fiber-based padding defining a second non-sinusoidal cross-sectional shape, in accordance with some embodiments discussed herein;

FIG. 3B illustrates a cross-sectional view of the example composite material with the example backing material and fiber-based padding shown in FIG. 3A taken along line 3-3, in accordance with some embodiments discussed herein;

FIG. 4A illustrates a schematic representation of an example roller forming the fiber-based padding to the first non-sinusoidal cross-sectional shape shown in FIG. 2B, in accordance with some embodiments discussed herein;

FIG. 4B illustrates a schematic representation of an example process for forming the fiber-based padding into the second non-sinusoidal cross-sectional shape shown in FIG. 3B using a flat plate, in accordance with some embodiments discussed herein;

FIG. 5A illustrates an example padded mailer, with a portion of the top panel removed to illustrate the padding within a cushioning section of the padded mailer, in accordance with some embodiments discussed herein;

FIG. 5B illustrates a cross-sectional view of the example padded mailer defining a first non-sinusoidal cross-sectional shape shown in FIG. 5A taken along line 5-5, in accordance with some embodiments discussed herein;

FIG. 5C illustrates an example container and a sheet of example fiber-based composite material for providing padded protection for items positioned within the container, in accordance with some embodiments discussed herein;

FIG. 6A illustrates a schematic representation of an example system for forming a roll of composite material, in accordance with some embodiments discussed herein;

FIG. 6B illustrates a schematic representation of an example system for forming a padded mailer, in accordance with some embodiments discussed herein;

FIG. 7 illustrates a flow chart of an example method for forming a padded composite material in accordance with some embodiments discussed herein;

FIG. 8 illustrates a flow chart of an example method for forming a padded mailer in accordance with some embodiments discussed herein; and

FIG. 9 shows a graph illustrating average peak acceleration measurements obtained during testing between traditional singleface and crushed singleface.

### DETAILED DESCRIPTION

Some example embodiments will now be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

The term “fiber-based” as used herein may refer to a material formed from fiber, such as from natural or synthetic sources. Such fiber may be a cellulose material known to chemists as a linear polysaccharide. Such fiber may, for example, come from wood, linens or fabric, plants, and/or wastepaper or other recycled paper products.

As noted herein, the composite material and/or the resulting structure, such as a padded mailer, is designed to be recyclable. The term “recyclable” as used herein may refer to a characteristic that enables something to be entered into recycling processes to be converted into new materials and/or objects. In some embodiments, the composite material and/or the resulting structure may be curbside recycled (e.g., it allows the composite material and/or the resulting structure to be introduced into a generally available curbside recycling stream).

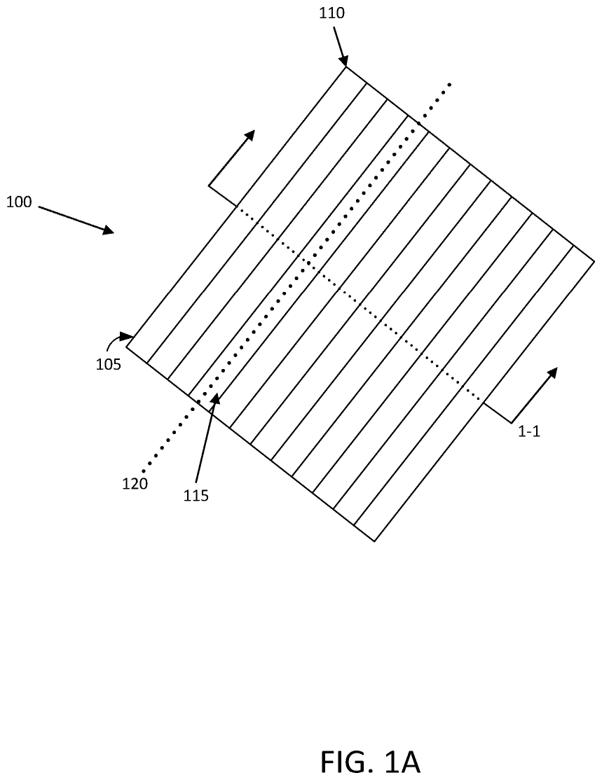

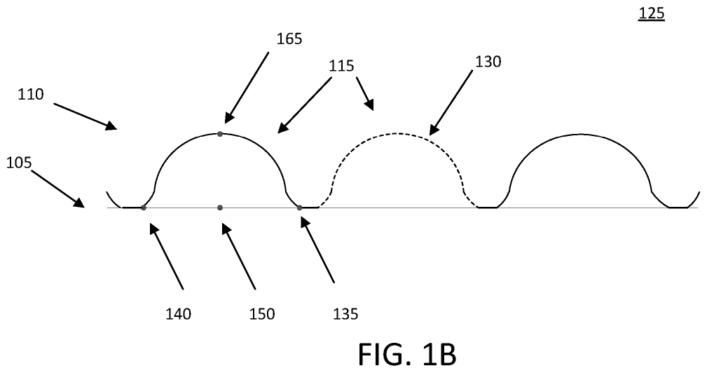

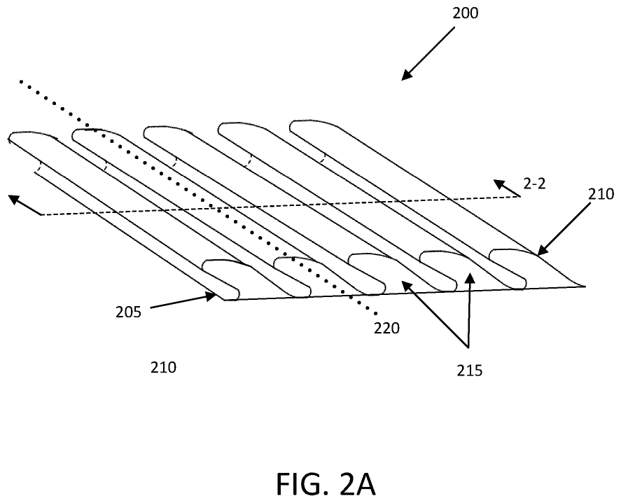

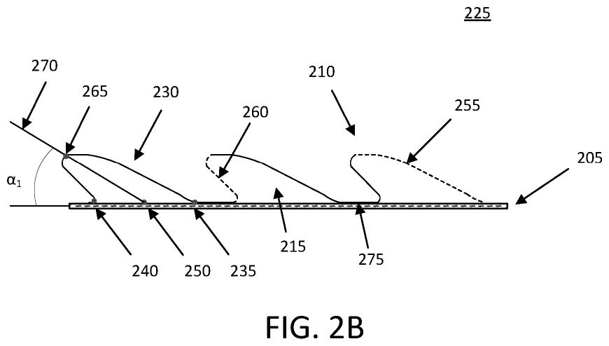

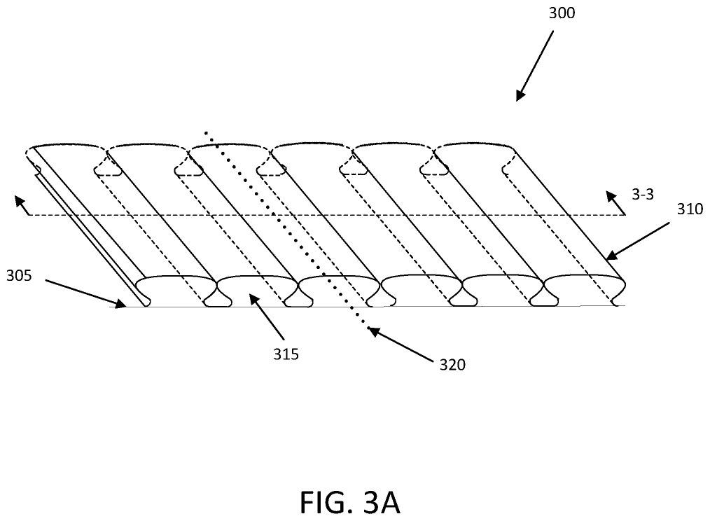

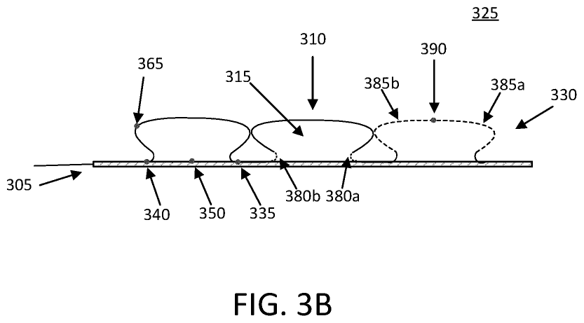

The term “sinusoidal” as used herein may refer to a smooth curve that has a shape corresponding to a sine curve (or a portion thereof). An example sinusoidal cross-sectional shape is shown in FIG. 1B. The term “non-sinusoidal” may refer to a curve or line that does not have a smooth curve with a shape corresponding to a sine curve. Some example non-sinusoidal cross-sectional shapes are illustrated in FIGS. 2B and 3B.

The term “apex” as used herein may refer to a point that corresponds to a local maximum. For example, one or more points along a cross-section for a tubular structure that are furthest away vertically from a backing material may define apex points. Example apex points are illustrated and described with respect to FIGS. 1B, 2B, and 3B.

The term “vertical” as used herein may refer to generally up and down (e.g., perpendicular) with respect to a plane corresponding to the composite material. To the extent a specific direction (e.g., up, down, side, etc.) is used, such terms are meant for explanatory purposes and are not designed to be limited to the specifically termed direction. In this regard, other directions are contemplated, such as based on different frames of reference.

FIG. 1A shows top view of an example fiber-based composite material 100 as contemplated by various embodiments of the present invention. With reference to FIG. 1B, the fiber-based composite material 100 includes a backing material 105 and a fiber-based padding material 110 attached to the backing material 105. The backing material 105 may be formed from a continuous web of fiber-based material. The fiber-based padding material 110 is formed of a plurality of tubular structures 115. In some embodiments, the padding material 110 is attached to the backing material 105 via an adhesive, which may be recyclable. The plurality of tubular structures 115, in some embodiments, may be formed from attaching a continuous web of fiber-based material to the backing material 105 (e.g., at one or two attachment points). In some embodiments, the tubular structures 115 may be individually formed and attached to the backing material 105 (e.g., from distinct portions of fiber-based material).

Each of the plurality of tubular structures 115 may have a length which extends along a longitudinal axis 120 extending across of the backing material 105. The tubular structures 115 may be parallel to each other and laterally spaced along the backing material 105. In some embodiments, the tubular structures 115 may be adjacent one another along the backing material 105.

In some embodiments, each of the tubular structures 115 may define a sinusoidal cross-sectional shape, such as illustrated in FIG. 1B (e.g., the cross-sectional shape of the padding material 110 may form a curve (including the part attached to or running parallel with the backing material 105) that approximates a sinusoidal curve). FIG. 1B illustrates an example cross-sectional plane 125 of the composite material 100, where the cross-sectional plane 125 may extend perpendicular to the backing material 105. Accordingly, a perimeter 130 of the tubular structure 115 may be defined within the cross-sectional plane 125. The perimeter 130 may be formed between a first point of attachment 135 and a second point of attachment 140 of the padding material 110 to the backing material 105. The perimeter 130 may extend vertically above and laterally along the backing material 105. Each tubular structure 115 may define an apex point 165 along the perimeter at a point where the perimeter 130 reaches a local maximum (e.g., the apex point 165 is a point along the perimeter 130 that has a maximum straight-line distance from a center point 150 and a maximum vertical distance from the backing material 105).

In some embodiments, the fiber-based composite material may be formed such that the padding material has a non-sinusoidal cross-sectional shape. In this regard, in some embodiments, such a shape of the padding material may provide desirable protection (e.g., shock absorption, crush protection, etc.) of items during shipping and handling.

In some embodiments, such padded protection may be particularly beneficial for relatively lighter items, e.g., having a weight of 10 lbs. or less (e.g., 7 lbs. or less, 3 lbs. or less, etc.). Notably, it has been observed that a typical single-face fluted medium, which forms a sinusoidal cross-sectional shape (e.g., shown in FIGS. 1A-B), does not provide desirable protection (e.g., crush protection) for such lighter items. In this regard, one line of thinking is that the single-face fluted medium is too rigid. A different non-sinusoidal cross-sectional shape (as detailed herein), however, has been observed to be an appropriate amount of rigidity that provides desirable protection (e.g., crush protection). Notably, the non-sinusoidal cross-sectional shape can also be adjusted or customized for the desired application, such as to specification requests by a customer (e.g., to protect a known item or set of known items). In this regard, the position of an apex point of the perimeter and/or angle α₁ (such as described with respect to FIG. 2A-B or 3A-B) may be adjusted.

In some embodiments, the padding may be designed for use with items that may be smaller and designed to fit inside the pouch of some padded mailers (e.g., padded mailers with surface area of ˜5 sq. ft. or less, 4 sq. ft. or less, etc.). Notably, however, embodiments of the present invention are designed to work with any suitable size padded delivery or storage option and any suitable weight range of item stored therein. For example, the composite material may be used for padding at the bottom of a container (e.g., the bottom of a watermelon carton). Similarly, the composite material may be provided in roll form and cut to a desired shape and/or size to provide customized padding solutions.

A fiber-based composite material with an example non-sinusoidal cross-sectional shape is illustrated in FIGS. 2A-B. FIG. 2A illustrates a top perspective view of a fiber-based composite material 200 including a backing material 205 and padding material 210 attached to the backing material 205. Notably, the padding material 210 forms a non-sinusoidal cross-sectional shape (e.g., a first example non-sinusoidal cross-sectional shape).

In this regard, FIG. 2B illustrates an example cross-sectional plane 225 of the composite material 200, where the cross-sectional plane 225 may extend perpendicular to a width direction of the backing material 205, wherein the width direction corresponds to a longitudinal axis 220 of the tubular structures 215 that each extend along the width direction of the backing material 205 when the composite material 200 is formed. Accordingly, a perimeter 230 of each tubular structure 215 may be defined within the cross-sectional plane 225. The perimeter 230 may be formed between a first point of attachment 235 and a second point of attachment 240 of the padding material 210 to the backing material 205. Each tubular structure 215 also includes a center point 250 positioned along the backing material 205 in the center between the first point of attachment 235 and the second point of attachment 240 with respect to the backing material 205.

In some embodiments, the padding material 210 may form a non-sinusoidal cross-sectional shape that leans at an angle. To explain, in the illustrated embodiment, the perimeter 230 includes a first portion 255, a second portion 260, and an apex point 265. In some embodiments that utilize continuous material to form the plurality of tubular structures, a portion 275 may extend along the backing material 205 between the tubular structures.

In some embodiments, the apex point 265 may be a point along the perimeter 230 that is a maximum straight-line distance from the center point 250 and a maximum vertical distance with respect to the backing material 205. Additionally or alternatively, the apex point 265 may be the point wherein the first portion 255 changes to the second portion 260 of the perimeter 230. In some embodiments, the first portion 255 extends away from the backing material 205 from the first point of attachment 235 to the apex point 265, and the second portion 260 extends from the apex point 265 back towards the backing material 205 at the second point of attachment 240. In some embodiments, the first portion 255 of the perimeter 230 extends in a first direction that is laterally towards a center point 250, and the second portion 255 of the perimeter 230 extends away from the second point of attachment 240 in a second direction laterally away from the center point 250. In some embodiments, the apex point 265 may be laterally further away from the center point 250 than the second point of attachment 240. In some embodiments, the apex point 265 extends along the longitudinal axis 220 of the tubular structure 215. In some embodiments, a line extending parallel to the longitudinal axis 220 and including the apex point 265 may form a fold (e.g., a crease) therealong. In some embodiments, utilizing a cross-sectional shape such as described with respect to FIGS. 2A-B may be beneficial in only forming one fold line (e.g., along or proximate the apex point) as compared to multiple fold lines that may be formed when the apex point is not laterally positioned with respect to the center point.

In some embodiments, a plane 270 may extend between the apex point 265 and the center point 250 and parallel to the longitudinal axis 220. The plane 270 (when viewed in the cross-sectional plane 225) may define an angle ai with the backing material 205 (which may correspond to its own plane—e.g., a backing material plane). In some embodiments, the angle α₁ may be within a range of 5° to 75° (although other ranges are contemplated, such as 5°-60°, 10°-60°, 15°-75°, 20°-45°, etc.). As shown in FIGS. 2A-2B, in some such embodiments, each of the tubular structures 215 may be oriented in the same direction (e.g., generally left in the view provided). In other embodiments, the tubular structures 215 may form different shapes (e.g., with different angles) and/or may be oriented differently from each other.

The padding material 210 may be formed into the non-sinusoidal cross-sectional shape in various ways. For example, in some embodiments, the padding material 210 may be formed into the shape by structuring the fiber-based material attaching to the backing material (e.g., around a correspondingly shaped removable structure) when forming the tubular structures. As another example, in some embodiments, the padding material 210 may be crushed (e.g., via application of one or more forces onto the padding material 210) to cause the padding material 210 to take on the non-sinusoidal cross-sectional shape (e.g., the padding material 210 shown in FIG. 2B may be in a “crushed state”). In some embodiments, the padding material 210 may enter the crushed state shown in FIG. 2B from an uncrushed state, such as may correspond to the sinusoidal cross-sectional shape shown in FIG. 1B. In some embodiments, an application of a crushing force applied in a direction not perpendicular to the backing material 205 may cause formation of a non-sinusoidal cross-sectional shape such as shown in FIG. 2B. In some embodiments, the direction of the crushing force may correlate to the angle α₁. In some embodiments, the padding material 210 may “bounce” back upwardly slightly after the crushing force is applied to form the non-sinusoidal cross-sectional shape. Depending on the circumstance, the padding material may define multiple different crushed states (e.g., different levels or degrees of crushed) after receiving a crushing force that transitions the padding material out of an uncrushed state (e.g., an original shape state during application of the fiber-based padding material onto the backing material).

Although the embodiment of the non-sinusoidal cross-section is shown such that the apex point 265 is shown extending beyond the second point of attachment 240, in some embodiments, the apex point may extend beyond the first point of attachment. Likewise, the apex point may not extend beyond either of the first point of attachment or the second point of attachment, but still be spaced laterally from the center point 250. Further, one of skill in the art would understand the first point of attachment, second point of attachment, and the first portion of the perimeter, and second portion of the perimeter are interchangeable.

Another example non-sinusoidal cross-sectional shape for the padding material is illustrated in FIGS. 3A-B. For example, FIG. 3A illustrates a top perspective view of a fiber-based composite material 300 having a backing material 305 and a fiber-based padding material 310 attached to the backing material 305. Notably, the padding material 310 forms a non-sinusoidal cross-sectional shape (e.g., a second example non-sinusoidal cross-sectional shape).

In this regard, FIG. 3B illustrates an example cross-sectional plane 325 of the composite material 300, where the cross-sectional plane 325 may extend perpendicular to the backing material 305. Accordingly, a perimeter 330 of a tubular structure 315 of the padding material 310 extends from a first point of attachment 335 to a second point of attachment 340. The perimeter 330 may include a first concave section 380a and a second concave section 380b, and a first convex section 385a and a second convex section 385b. In some embodiments, the first concave section 380a extends from the first point of attachment 335 to the first convex section 385a, and the second concave section 380b extends from the second point of attachment 340 to the second convex section 385b. The first and second convex sections 385a, 385b meet at a middle point 390 on the perimeter 330. In some embodiments, the perimeter 330 of the tubular structure 315 may be laterally symmetrical about the middle point 390 and a center point 350 on the backing material 305 between the first point of attachment 335 and the second point of attachment 340, while in other embodiments the perimeter 330 may be mostly laterally symmetrical. In some embodiments, the middle point 390 may form an apex point. The padding material 310 may be formed into the non-sinusoidal cross-sectional shape in various ways. For example, in some embodiments, the padding material 310 may be formed into the shape by structuring the fiber-based material attaching to the backing material (e.g., around a correspondingly shaped removable structure) when forming the tubular structures. As another example, in some embodiments, the padding material 310 may be crushed (e.g., via application of one or more forces onto the padding material 310) to cause the padding material 310 to take on the non-sinusoidal cross-sectional shape (e.g., the padding material 310 shown in FIG. 3B may be in a “crushed state”). In some embodiments, the padding material 310 may enter the crushed state shown in FIG. 3B from an uncrushed state, such as may correspond to the sinusoidal cross-sectional shape shown in FIG. 1B. In some embodiments, an application of a crushing force applied in a direction perpendicular to the backing material 305 may cause formation of a non-sinusoidal cross-sectional shape such as shown in FIG. 3B. In some embodiments, the padding material 310 may “bounce” back upwardly slightly after the crushing force is applied to form the non-sinusoidal cross-sectional shape.

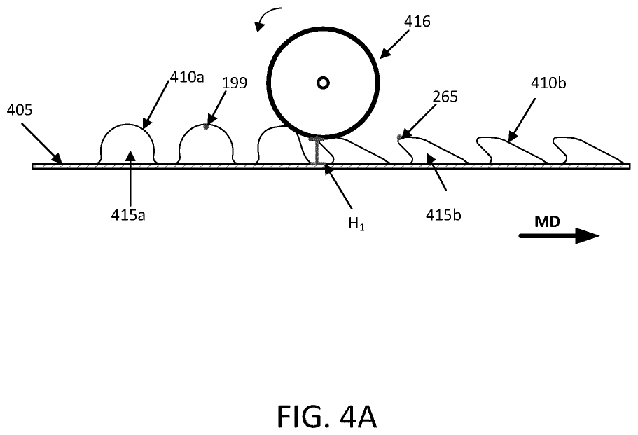

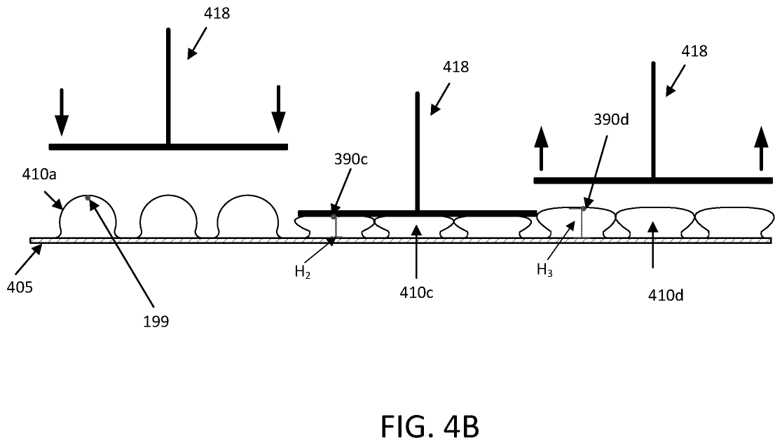

FIG. 4A illustrates an example process where padding material 410a having a sinusoidal cross-sectional shape is formed into padding material 410b having a non-sinusoidal cross-sectional shape. In this regard, the tubular structures 415a may undergo a crushing process wherein a crushing force is applied to each of the tubular structures at a non-perpendicular angle (i.e., the force is not perpendicular to the backing material 405). In some embodiments, as shown in FIG. 4A, the crushing force may be applied by a roller 416. Accordingly, the backing material 405 may translate along a machine direction MD to cause the tubular structures 415a to interact with the roller 416 to receive the crushing force. The tubular structures 415a undergo the crushing force by the roller 416 and result in tubular structures 415b, such as shown in FIG. 2A. For example, referring back to FIG. 4A, an apex point 199 in the uncrushed state is changed to a new location closer to the backing material 405, as shown by the apex point 265 in the crushed state. The roller 416 may be positioned at a height H₁ above the backing material 405, such that the height H₁ is the distance from the backing material 405 to the bottom point of the roller 416. As the height H₁ changes the angle α₁ will also change, such that a smaller height leads to a smaller angle between the apex point and the backing material (consider FIG. 2B and the corresponding description), and a larger height leads to a larger angle between the apex and the backing material (consider FIG. 2B and the corresponding description). While the above description utilizes a roller 416 to apply the crushing force in a non-perpendicular direction, other suitable force application means are contemplated, such as via one or more plates (e.g., at an angle), utilizing a non-rotating object, having the roller 416 move laterally across the backing material 405 (e.g., with or without movement of the backing material 405), etc.

In some embodiments, the padding material may be formed to have a non-sinusoidal cross-sectional shape by applying a force that is perpendicular to the backing material 405. FIG. 4B illustrates an example crushing process. The sinusoidal “uncrushed” padding material 410a may be crushed, for example, by a plate 418 exerting a force perpendicular to the backing material 405. In some embodiments, an intermediate state of the padding material 410c is reached such that the tubular structure has a smaller height H₂ than the final product height H₃. After the plate 418 applies the perpendicular force, the force is relieved by removal of the plate 418. The resulting padding material 410d is then in a crushed state that forms a second non-sinusoidal cross-sectional shape (e.g., as shown in FIG. 3A). For example, referring back to FIG. 4B, an apex point 199 in the uncrushed state is changed to a new location closer to the backing material 405, as shown by the apex point 390c in the intermediate state and the apex point 390d in the crushed state. Although the above description details a “bounce” back of the shape of the padding material, in some embodiments, there may not be a “bounce” back. Further, while the above description utilizes a plate 418 to apply the crushing force in a perpendicular direction, other force application means are contemplated, such as via one or more rollers, utilizing a non-rotating object, having the plate 418 (or other object) move laterally across the backing material 405 (e.g., with or without movement of the backing material 405), etc.

In some embodiments, all of the padding material may be crushed, whereas in other embodiments, just some of the padding material may be crushed. For example, certain ones of the tubular structures may be crushed while others are not crushed. Similarly, different degrees of crushing may be applied to various tubular structures of the padding material. In some embodiments, just certain sections of one or more tubular structures may be crushed (or have different degrees of crush) applied to them. For example, the section of the padding material that is designed for the pocket to hold the item(s) of the padded mailer may have a different degree of crush than some other sections of the padding material. As is consistent with the description herein, similar concepts may be applied when forming the tubular structures (e.g., where the non-sinusoidal cross-sectional shape is formed during application instead of after crushing).

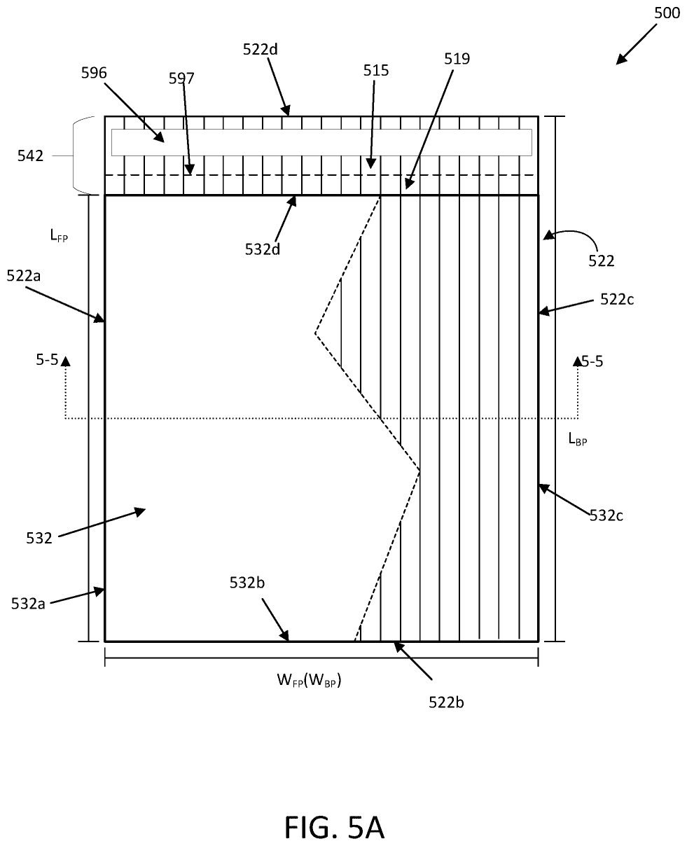

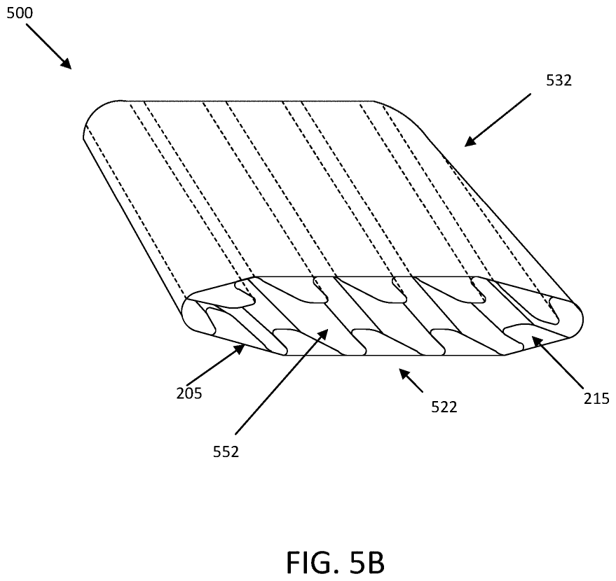

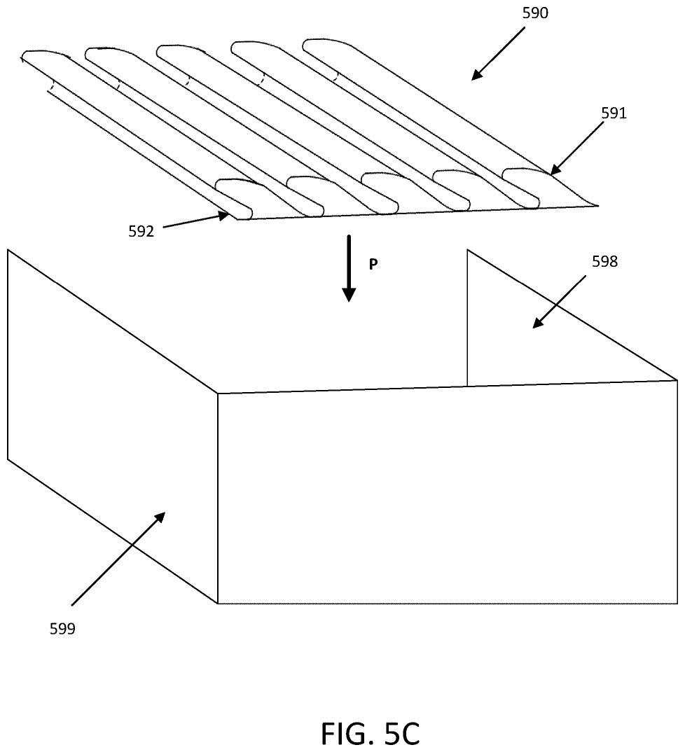

FIG. 5A shows an example padded mailer 500 contemplated by various embodiments of the present invention. The illustrated padded mailer 500, which is shown in the open, ready for packaging configuration, includes a front panel 532 and a back panel 522. Each of the front panel 532 and the back panel 522 may be constructed from the fiber-based composite material (e.g., fiber-based composite material 200, 300), wherein the backing material (e.g., backing material 205, 305) forms the outside of the mailer 500, and the fiber-based padding (e.g., padding material 210, 310) forms the inside of the mailer 500 (e.g., the side of the composite material without the padding material forms the outer surface of the mailer, and the side of the composite material with the padding forms the internal surface of the pouch of the mailer).

The front panel 532 defines a width W_{FP} and a length L_{FP} and includes four edges 532a, 532b, 532c, and 532d. The back panel 522 defines a width W_{BP} and a length L_{BP} and includes four edges 522a, 522b, 522c, and 522d. In the open, ready for packaging configuration, the front panel 532 and the back panel 522 are attached along three edges (522a/532a, 522b/532b, and 522c/532c), such as via seam adhesive being positioned proximate the edges. Notably, the fourth edge 5320d of the front panel 532 is not attached to the back panel 522 (or only attached near the corners) and, instead, an opening 519 to a pocket 552 (e.g., pouch) (shown in FIG. 5B) is formed—allowing insertion of the item(s) for shipping and delivery. Notably, the padding of the composite material used to form the front panel 532 and the back panel 522 is positioned to face internally into the pouch so as to provide padded protection for one or more items when the items are located in the pouch.

The dimensions of the padded mailer may vary depending on the desired application. An example padded mailer includes a back panel length L_{BP} of ˜20.125 in. and a back panel width W_{BP} of ˜14 in. In some embodiments, the closed mailer may have dimensions of 12 in by 18 in, or 24 in by 24 in. In some embodiments, the padded mailer may be configured to accommodate an item(s) up to 10 pounds, an item(s) up to 7 pounds, or an item(s) less than 3 pounds. Although, example sizes and weights are included, various size padded mailers are contemplated.

Notably, the length L_{BP} of the back panel 522 is greater than the length L_{FP} of the front panel 532 such that a portion 542 of the back panel 522 extends above the fourth edge 532d of the front panel 532. The portion 542 of the back panel 522 can, thus, be used in sealing the padded mailer 500, such as once the item to be shipped and delivered is placed inside. In this regard, various features for aiding in packaging and opening of the padded mailer can be positioned within the portion 542. For example, FIG. 5A illustrates an example pull-strip 596 for revealing a strip of adhesive (which, in some embodiments, may be recyclable) that can be used to attach the portion 542 to the front panel 532 once the portion 542 has been folded over to cover the opening 519—thereby transitioning the padded mailer into a sealed configuration. Once the sealed padded mailer has been delivered to its end destination, a tear strip 597 can be pulled to enable access to the internal pocket 552 and, thus, the item stored therein.

Notably, embodiments of the present invention contemplate various features and configurations of a padded mailer that can be utilized. Thus, the illustrated example is not meant to be limiting. For example, in some embodiments, the front panel and the back panel may have similar lengths, the front panel and the back panel may be attached around an item, and/or other configurations are contemplated. Likewise, although the longitudinal axis of the padding material is shown running in parallel with the length direction in FIG. 5A of the padded mailer 500, some or all of the padding material may form a different relative direction with respect to the shape of the padded mailer (e.g., the padding material may be perpendicular to the length direction shown in FIG. 5A, at an angle, or otherwise oriented).

With reference to FIG. 5B, the panels 522, 532 connect along the edges to form a pocket 552 for receiving the item to be shipped and delivered therein. FIG. 5B illustrates a mailer 500 with the first non-sinusoidal cross-sectional shape (shown in FIG. 2B). The pocket 552 is formed between the tubular structures 215, such that the item to be shipped may be in direct contact with the padding of the non-sinusoidal tubular structures 215. In some embodiments, the mailer 500 may be formed by folding the composite material 200 in half so only two edges of the mailer need to be adhered together. While in other embodiments the mailer may be formed from two or more webs of the composite material 200.

As noted herein, embodiments of the present invention are designed to work with any suitable size padded delivery or storage option and any suitable weight range of item stored therein. In this regard, though the above example details an example padded mailer, other structures are contemplated. For example, the composite material may be used to form all or part of a container for shipping (e.g., a shipping box or other shape). As another example, the composite material may be used as padding in other forms, such as being cut into a shape (e.g., a rectangle) and placed (or attached) somewhere to provide desired padding. As an example, with reference to FIG. 5C, the fiber-based composite material 590 could be cut into a rectangular sheet (e.g., including the padding material 591 on the backing material 592), and that sheet may be placed (e.g., along arrow P) through an opening 598 and to the bottom of a container 599—thereby providing padded protection for any suitable items placed therein. Since the tubular structures 215 are exposed to the item, each tubular structure in contact with the item may provide support and padding, while the other structures remain in their designed non-sinusoidal structure.

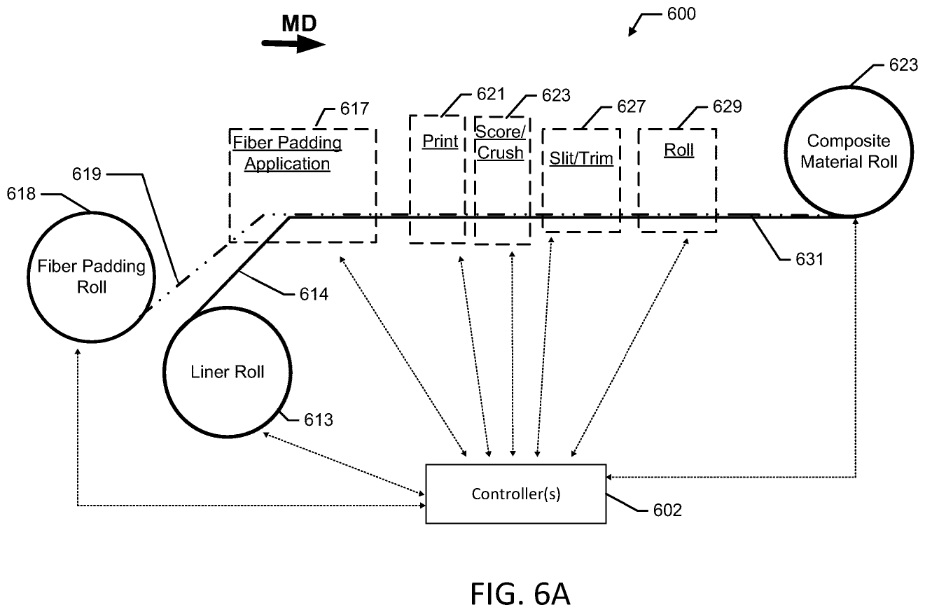

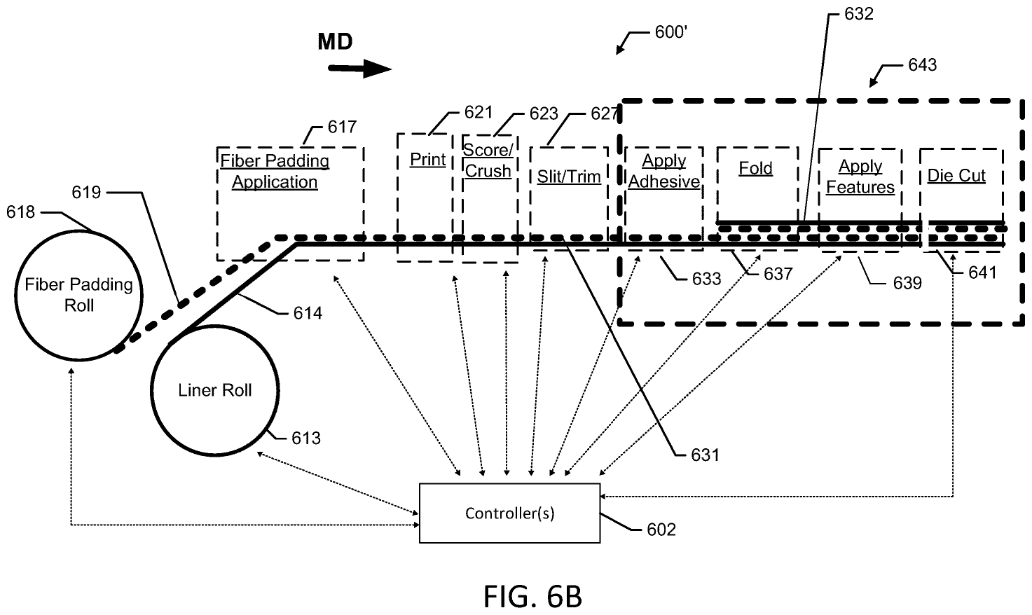

FIG. 6A shows a schematic representation of an example system 600 for forming a fiber-based padding material. The system 600, such as through controller 602, may cause conveyance of one or more paper-based webs, (i.e., a fiber-based web) such as along the machine direction (MD) arrow. The conveyor means (e.g., conveyor belt, one or more rollers etc.) and/or motors may be used to cause a roll 613 of a first web 614 of backing material to pass through fiber padding application phase 617. The conveyor means may also cause a roll 617 of a second web 619 of fiber-based padding to pass through the fiber padding application phase 617. At the fiber padding application phase 617, the fiber-based padding may be attached (e.g., adhered) to the backing material forming a padded fiber-based composite material web 631.

In some embodiments, the fiber-based padding may be applied in an uncrushed state (e.g., in the sinusoidal shape shown in FIG. 1A). Alternatively, the fiber-based padding may be applied into the desired non-sinusoidal shape, such as described herein.

After formation of the composite material web 631, the conveyor means may cause the fiber-based composite material web 631 to pass through one or more of a print phase 621, a score/crush phase 623, and a slit/trim phase 627. After that, the conveyor means may cause the padded fiber-based composite material 631 to enter a roll phase 629 (such as to form a roll 623 of the padded composite material). Such a roll 623 may be moved or shipped, such as for further processing elsewhere. For example, the roll 623 may be shipped to a customer for utilization with various packaging processes (e.g., to form their own structures or uses of the composite material). For example, the composite material may be feed into an automated packaging machine.

Alternatively, in some embodiments, additional processing may be performed in-line, such as to form desired products from the composite material. For example, a padded mailer may be formed. FIG. 6B illustrates example additional processing that may be utilized to form an example padded mailer. In this regard, FIG. 6B illustrates a schematic representation of the example system 600′ for forming a fiber-based composite material including phases to make a fiber-based padded mailer (i.e. the padded mailer 500 of FIG. 5A). The system 600′ may, through controller 602, rather than enter the roll phase 629, cause the fiber-based composite material web 631 to enter one or more product formation phases 643, such as an adhesive application phase 633, a folding phase 637, a feature application phase 639, and a cutting phase 641. Notably, in conjunction with various embodiments described herein, various of the phases can be combined, changed in order of operation, separated, or otherwise changed. For example, the fiber-based composite material web may be folded over onto itself to form one or more of the internal pouches and/or the pocket of the padded mailer. In such example embodiments, the corresponding phases may be adjusted accordingly.

The following provides further example description of the various features/components and/or phases corresponding to the systems 600, 600′. In this regard, depending on the desired end product, different features/components and/or phases may be employed.

The controller 602 provides logic and control functionality used during operation of the system 600, 600′. In some embodiments, the functionality of the controller 602 may be distributed to several controllers that each provides more limited functionality to discrete portions of the operation of system 600, 600′. The controller 602 may comprise one or more suitable electronic device(s)/server(s) capable of executing described functionality via hardware and/or software control. In some embodiments, the controller 602 may include one or more user interfaces (not shown), such as for displaying information and/or accepting instructions. The controller 602 can be, but is not limited to, a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a solid-state computer, a single-board computer, a buffered computer, a computer network, a desktop computer, a laptop computer, a personal digital assistant (PDA) or a hybrid of any of the foregoing.

The controller 602 may include one or more processors coupled to a memory device. Controller 602 may optionally be connected to one or more input/output (I/O) controllers or data interface devices (not shown). The memory may be any suitable form of memory such as an EPROM (Erasable Programmable Read Only Memory) chip, a flash memory chip, a disk drive, or the like. As such, the memory may store various data, protocols, instructions, computer program code, operational parameters, etc. In this regard, the controller 602 may include operation control methods embodied in application code. These methods are embodied in computer instructions written to be executed by one or more processors, typically in the form of software. The software can be encoded in any suitable language, including, but not limited to, machine language, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any suitable combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software. In this regard, in some embodiments, the controller 602 may be configured to execute computer program code instructions to perform aspects of various embodiments of the present invention described herein.

The controller 602 may be operably coupled with one or more components of the system 600, 600′, including for example, the roll 613 of backing material of the first web 614 (or corresponding web management device for controlling translation of the first web 614 along the web path), the roll 618 of the fiber-based padding of the second web 619 (or corresponding web management device for controlling translation of the second web 619 along the web path), various components of the fiber padding application phase 617, various components of the printing phase 621, various components of the score/crush phase 623, various components of the slit and/or trim phase 627, various components of the roll phase 629, the roll 623 of the padded composite material of the resulting web 631 (or corresponding web management device for controlling the translation of the composite material resulting web 631 along the web path), various components of the adhesive application phase 633, various components of the folding phase 637, various components of the feature application phase 639, various components of the cut phase 641, conveyance means of the system 600, 600′, and other components (such as described herein). For example, depending on the components, the controller 602 may be operably coupled such as through use of solid-core wiring, twisted pair wiring, coaxial cable, fiber optic cable, mechanical, electrical, wireless, radio, infrared, etc. In this regard, depending on the components, the operable coupling may be through one or more intermediate controllers or mechanical coupling, such as used for controlling some components (e.g., controlling operation and/or feeding of the roll 613 of the first web 614). In some embodiments, the controller 602 may be configured to provide one or more operating signals to these components and to receive data from these components.

During the fiber padding application phase 617, the controller 602 may be configured to cause application of the second web 619 onto the first web 614 (e.g., attachment of the second web 619 to the first web 614). The controller 602 may be further configured to apply an adhesive in a determined amount to the first web 614 (e.g., at the first and second attachment points) and form the second web 619 into a tubular structure with the appropriate cross-section, such as that seen in FIGS. 1A-3B. The fiber padding application phase 617 may also involve cutting the second web 619 into individual pieces, which are each adhered to the continuous first web 614 of the backing material.

During the printing phase 621, the controller 602 may direct a printer to print one or more images at specific locations on the first web 614. Any suitable image (including words, markers, instructions, etc.) are contemplated by various embodiments of the present invention. For example, various labels corresponding to the padded mailer (and/or the composite material) may be printed onto the first web (such as the face of the first web that will face outside of the padded mailer). As another example, a barcode or other identifier may be printed to be used, such as during shipping and/or delivery.

During the score and/or crush phase 623, the controller 602 may be configured to score and/or crush the composite material. Such scoring or crushing may be related to various features of the end product (e.g., crush a portion of the material corresponding to the edges or the strip adhesive, prepare the material for folding, etc.). Additionally or alternatively, in some embodiments, the crushing may be applied to the padding material such as to form the non-sinusoidal cross-sectional shapes (e.g., transition the padding material from an uncrushed state to a crushed stated). For example, the crushing may include application of a force to the padded composite material (e.g., perpendicular to or non-perpendicular to the backing material of the composite material). For example, the composite material may be passed under/through a roller (e.g., roller 416 of FIG. 4A) or a plate (e.g., plate 418 of FIG. 4B) and corresponding crushing may occur, such that the sinusoidal cross-sectional shape of the composite material is formed into a non-sinusoidal cross-sectional shape, yielding the desired shape of padded composite material. In this regard, in some embodiments where the tubular structures are already formed into the non-sinusoidal cross-sectional shape, such crushing may not occur.

When operating in system 600, during the roll phase 629, the controller 602 may be configured to cause the rolling of the padded composite material. For example, such padded composite material may be formed into a roll 623 for transportation. In some embodiments, after the padded material is formed additional processing and logistics corresponding with the manufacturing process may thereafter take place.

When operating in system 600′, during the adhesive application phase 633, the controller 602 may be configured to cause application, such as from an adhesive application device, of adhesive onto portions of the composite material 631. For example, such adhesive may be applied to ultimately help attach the composite material 631 (which may form a first panel) to a second web of composite material 632 (which may form a second panel) to form the padded mailer. In some embodiments, instead of a second web of composite material 632 being used, the first web of composite material 631 may be simply folded over.

During the folding phase 637, one or more folds may be applied to the web of padded mailer. This may help form various features, such as the top flap. In some embodiments, the folding phase 637 may be utilized to fold over the composite material so as to form both panels (such as described above).

During the feature application phase 639, the controller 602 may be configured to cause application of one or more features to the padded mailer, such as may be used for packaging and/or opening of the padded mailer. For example, with reference to FIG. 5A, a strip of adhesive and a corresponding pull-strip for revealing the strip of adhesive can be applied. As another example, a tear strip can be applied. Other features or additions to the padded mailer are also contemplated.

During the cut phase 641, the controller 602 may be configured to cut out the padded mailers (which may still be connected along their lengths since they may be folded as a web form). In this regard, the controller 602 may be operably coupled to the various knives to control operation during the cutting phase 641. After the padded mailer is cut additional processing and logistics corresponding with the manufacturing process may thereafter take place.

### Example Flowchart(s)

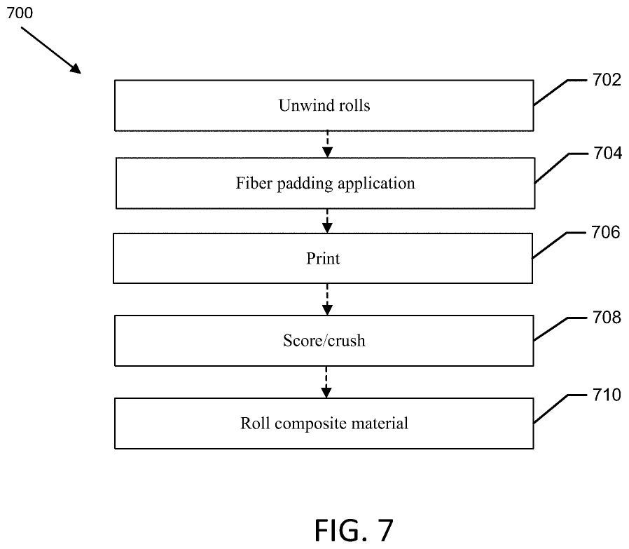

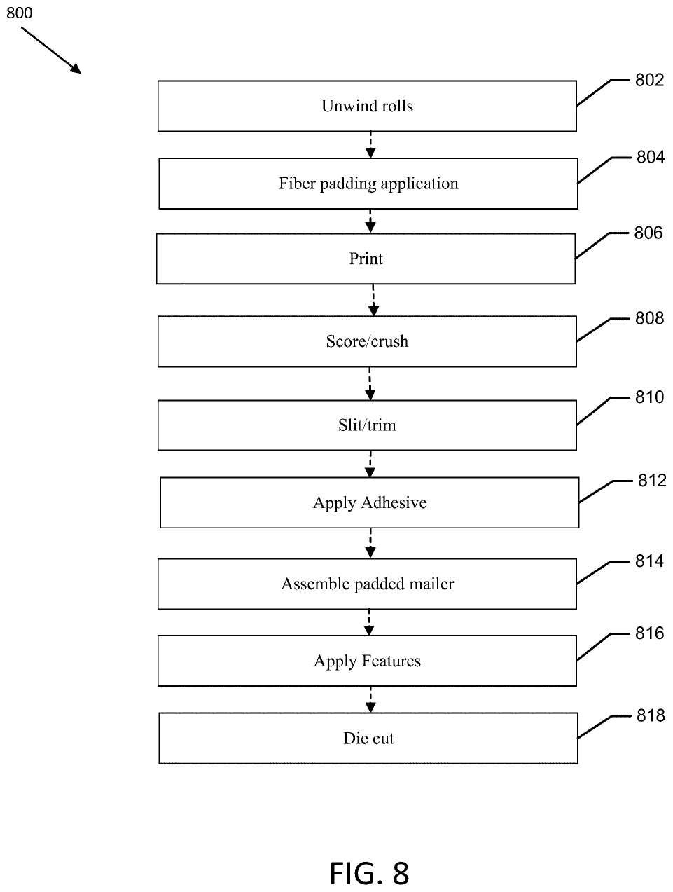

Embodiments of the present invention provide methods, apparatuses and computer program products for controlling the various components/features according to various systems described herein. Various examples of the operations performed in accordance with embodiment of the present invention will now be provided with reference to FIGS. 7-8.

FIG. 7 illustrates a flowchart according to an example method for forming a padded fiber-based composite material according to an embodiment. Notably, while FIG. 7 provides a flow of various operations, the order of occurrence of the operations is not meant to be limited to that illustrated in FIG. 7 and may vary within embodiments of the present invention. In some embodiments, however, the order of operations and/or certain operations may be necessary, where others may be optional—such as corresponding to described embodiments herein. The operations illustrated in and described with respect to FIG. 7 may, for example, be performed by, with the assistance of, and/or under the control of one or more controller 602 and other components/features described herein, such as in the system 600.

The method 700 may include unwinding one or more rolls at operation 702 (e.g., the fiber padding roll 618 and/or the backing material roll 613). At operation 704, the method may comprise applying the fiber-based padding to the backing material. At operation 706, the method may comprise printing on the backing material. At operation 708, the method may comprise scoring or crushing the composite material. At operation 710, the method may include rolling the fiber-based composite material into a roll, which may be used at a later time.

FIG. 8 illustrates a flowchart according to an example method for forming a padded mailer according to an example embodiment. Notably, while FIG. 8 provides a flow of various operations, the order of occurrence of the operations is not meant to be limited to that illustrated in FIG. 8 and may vary within embodiments of the present invention. In some embodiments, however, the order of operations and/or certain operations may be necessary, where others may be optional—such as corresponding to described embodiments herein. The operations illustrated in and described with respect to FIG. 8 may, for example, be performed by, with the assistance of, and/or under the control of one or more controller 602 and other components/features described herein, such as in the system 600′.

The method 800 may include unwinding rolls at operation 802 (e.g., the fiber padding roll 618 and/or the backing material roll 613). At operation 804, the method may comprise applying the fiber-based padding to the backing material. At operation 806, the method may comprise printing on the backing material. At operation 808, the method may comprise scoring or crushing the composite material.

At operation 810, the fiber-based composite material may be slit or trimmed. At operation 812, the method may comprise applying an adhesive to the fiber-based composite material, such as for combining with another web or another portion of the composite material to form the padded mailer. At operation 814, the composite material may be folded. At operation 816, various features may be applied to the padded mailer. At operation 818, the padded mailer may be cut out.

FIGS. 7-8 illustrate flowcharts of various systems, methods, and computer program product according to various example embodiments described herein. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory and executed by, for example, the controller 602. As will be appreciated, any suitable such computer program product may be loaded onto a computer or other programmable apparatus, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

### Example Test Data

As detailed herein, various embodiments provide fiber-based composite material that may be formed such that the padding material has a non-sinusoidal cross-sectional shape that, as described herein, may be formed in a number of different ways. In this regard, in some embodiments, such a shape of the padding material may provide desirable protection (e.g., shock absorption, crush protection, etc.) of items during shipping and handling.

The following provides results of various performance testing performed on traditional A-Flute singleface material versus A-Flute singleface material that was crushed to form a non-sinusoidal cross-sectional shape as described herein. In this regard, a roll of A-Flute singleface material was procured from ULINE and cut into square specimens with dimensions of 8″ in the X and Y direction (total surface area of 64 square inches). Half of the specimens were unaltered, and the other half were crushed to form a non-sinusoidal cross-sectional shape. Notably, the crushing resulted in a non-sinusoidal cross-sectional shape that included a plane extending along the longitudinal axis and between a center point and an apex point of the perimeter of the cross-section, wherein the plane defined an angle with the backing material that is greater than 5 degrees and less than 75 degrees.

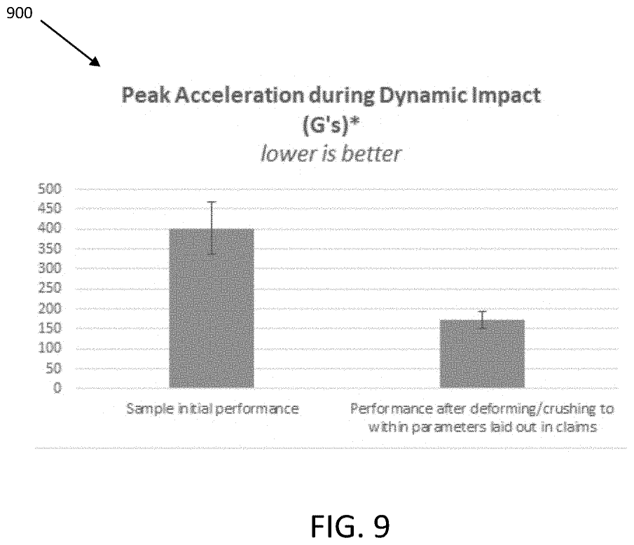

The specimens were tested per American Society of Testing and Materials (“ASTM”) D1596, “Standard Test Method for Dynamic Shock Cushioning Characteristics of Packaging Material”. To perform this test method, a metal platen with dimensions larger than the specimen was dropped onto the specimen cushioned face (in the Z direction). The method included measuring peak acceleration experienced by the platen during the impact. In particular, 3 specimens of each kind (3 specimens of traditional singleface and 3 specimens of crushed singleface) were used, and 5 repeated drops of a static load of 0.034 psi occurred from a height of 13 inches on each specimen. The results of each drop and measured peak acceleration in G's are shown in Table A: Test Data on the following page. The average peak acceleration for each specimen was determined and then the average overall peak acceleration between traditional singleface and crushed singleface was determined and used to prepare the graph of FIG. 9.

TABLE A
Test Data

| | | Drop | Peak Acceleration | Specimen |
|---|---|---|---|---|
| Sample Type | Specimen # | Repeat # | (G's) | Average |
| Initial | 1 | 1 | 437 | 389 |
| (not crushed) | | 2 | 348 | |
| | | 3 | 415 | |
| | | 4 | 385 | |
| | | 5 | 357 | |
| | 2 | 1 | 464 | 432 |
| | | 2 | 453 | |
| | | 3 | 517 | |
| | | 4 | 381 | |
| | | 5 | 346 | |
| | 3 | 1 | 343 | 385 |
| | | 2 | 395 | |
| | | 3 | 369 | |
| | | 4 | 403 | |
| | | 5 | 416 | |
| After | 1 | 1 | 158 | 165 |
| deforming/ | | 2 | 170 | |
| crushing to within | | 3 | 156 | |
| parameters laid | | 4 | 162 | |
| out in claims | | 5 | 177 | |
| | 2 | 1 | 202 | 183 |
| | | 2 | 182 | |
| | | 3 | 180 | |
| | | 4 | 172 | |
| | | 5 | 177 | |
| | 3 | 1 | 200 | 171 |
| | | 2 | 160 | |
| | | 3 | 163 | |
| | | 4 | 152 | |
| | | 5 | 180 | |

Turning to FIG. 9, as can be seen, all of the specimens of the traditional singleface (left side) achieved an average peak acceleration of 402 G's, whereas all of the specimens of the crushed singleface (right side) achieved an average peak acceleration of 173 G's. Notably, a cushion material is more effective if it is able to achieve a lower peak acceleration value. Thus, peak acceleration measurements taken from the non-sinusoidal material (right side) averaged 57% lower (better) than the unaltered singleface (e.g., sinusoidal) material (left side).

### CONCLUSION

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A fiber-based composite material comprising:
a fiber-based backing material; and
a fiber-based padding attached to the backing material for providing cushioning, wherein the padding comprises a plurality of tubular structures,
wherein each of the plurality of tubular structures defines a longitudinal axis extending along the backing material,
wherein each of the plurality of tubular structures defines a cross-section in a cross-sectional plane perpendicular to the longitudinal axis, wherein the cross-section defines a perimeter extending from a first point of attachment to the backing material to a second point of attachment to the backing material, wherein the perimeter includes an apex point,
wherein, in the cross-sectional plane, the apex point is spaced apart both laterally and vertically from a center point on the backing material that is positioned between the first point of attachment and the second point of attachment and along the longitudinal axis, such that a plane extending along the longitudinal axis and connecting the center point and the apex point defines an angle with the backing material that is greater than 5 degrees and less than 75 degrees.

2. The fiber-based composite material of claim 1, wherein the apex point along the perimeter is a point along a fold in the tubular structure.

3. The fiber-based composite material of claim 1, wherein a first portion of the perimeter extends away from the backing material from the first point of attachment to the apex point along the perimeter, wherein a second portion of the perimeter extends back toward the backing material from the apex point to the second point of attachment.

4. The fiber-based composite material of claim 3, wherein the apex point is laterally further away from the center point than the second point of attachment is away from the center point, and wherein the apex point is laterally closer to the second point of attachment than to the first point of attachment.

5. The fiber-based composite material of claim 3, wherein the first portion of the perimeter extends away from the first point of attachment in a first direction that is laterally toward the center point, and wherein the second portion of the perimeter extends away from the second point of attachment in a second direction that is laterally away from the center point.

6. The fiber-based composite material of claim 1, wherein the angle between the backing material and the plane connecting the center point and the apex point is between 10 degrees and 60 degrees.

7. The fiber-based composite material of claim 1, wherein the plurality of tubular structures are attached to the backing material in parallel relation to each other.

8. The fiber-based composite material of claim 1, wherein each of the plurality of tubular structures define an uncrushed state and a crushed state, wherein each of the plurality of tubular structures enter the crushed state from the uncrushed state via application of a crushing force that occurs after the plurality of tubular structures are attached to the backing material, wherein the application of the crushing force is in a non-perpendicular direction with respect to the backing material.

9. The fiber-based composite material of claim 1, wherein each of the plurality of tubular structures define an uncrushed state and a crushed state, wherein each of the plurality of tubular structures enter the crushed state from the uncrushed state via application of a crushing force that occurs after the plurality of tubular structures are attached to the backing material, wherein the application of the crushing force is in a perpendicular direction with respect to the backing material.

10. The fiber-based composite material of claim 1, wherein the plurality of tubular structures were formed into a crushed state during attachment to the backing material.

11. The fiber-based composite material of claim 1, wherein the plurality of tubular structures are formed from a continuous web of fiber-based material.

12. The fiber-based composite material of claim 1, wherein each of the plurality of tubular structures is formed from a distinct portion of fiber-based material.

13. The fiber-based composite material of claim 1, further defining a shape that is formable into the mailer defining a pouch for receiving the one or more items therein, wherein the padding is positioned along the shape such that the padding forms an internal surface of the pouch so as to provide padded protection for the one or more items when the one or more items are located in the pouch.

14. The fiber-based composite material of claim 1, wherein the fiber-based composite material is formed into a roll.

15. The fiber-based composite material of claim 1, wherein the fiber-based padding is attached to the backing material using a recyclable adhesive.

16. A mailer formed from a fiber-based composite material, wherein the fiber-based composite material comprises:
a fiber-based backing material; and
a fiber-based padding attached to the backing material for providing cushioning to one or more items within the mailer, wherein the padding comprises a plurality of tubular structures, wherein each of the plurality of tubular structures defines a longitudinal axis extending along the backing material,
wherein each of the plurality of tubular structures defines a cross-section in a cross-sectional plane perpendicular to the longitudinal axis, wherein the cross-section defines a perimeter extending from a first point of attachment to the backing material to a second point of attachment to the backing material, wherein the perimeter includes an apex point,
wherein, in the cross-sectional plane, the apex point is spaced apart both laterally and vertically from a center point on the backing material that is positioned between the first point of attachment and the second point of attachment and along the longitudinal axis, such that a plane extending along the longitudinal axis and connecting the center point and the apex point defines an angle with the backing material that is greater than 5 degrees and less than 75 degrees.

17. The mailer of claim 16 further comprising a pouch for receiving the one or more items therein, wherein the padding forms an internal surface of the pouch so as to provide padded protection for the one or more items when the one or more items are located in the pouch.

18. The mailer of claim 16, wherein the mailer is formed with the fiber-based material using a recyclable adhesive.

19. A method for forming a mailer, the method comprising:
providing a fiber-based composite material comprising:
a fiber-based backing material; and
a fiber-based padding attached to the backing material for providing cushioning to one or more items within the mailer, wherein the padding comprises a plurality of tubular structures, wherein each of the plurality of tubular structures defines a longitudinal axis extending along the backing material,
wherein each of the plurality of tubular structures defines a cross-section in a cross-sectional plane perpendicular to the longitudinal axis, wherein the cross-section defines a perimeter extending from a first point of attachment to the backing material to a second point of attachment to the backing material, wherein the perimeter includes an apex point,
wherein, in the cross-sectional plane, the apex point is spaced apart both laterally and vertically from a center point on the backing material that is positioned between the first point of attachment and the second point of attachment and along the longitudinal axis, such that a plane extending along the longitudinal axis and connecting the center point and the apex point defines an angle with the backing material that is greater than 5 degrees and less than 75 degrees; and
forming the mailer using the fiber-based composite material.

20. The method of claim 19, further comprising forming a pouch in the mailer for receiving the one or more items therein, wherein the pouch is formed such that the padding forms an internal surface of the pouch so as to provide padded protection for the one or more items when the one or more items are located in the pouch.

21. The method of claim 19, wherein each of the plurality of tubular structures define an uncrushed state and a crushed state, wherein each of the plurality of tubular structures is in the crushed state when the apex point is spaced apart both laterally and vertically from the center point on the backing material, wherein the method further comprises crushing the fiber-based composite material to cause each of the plurality of tubular structures to form the crushed state by applying a force in a non-perpendicular direction with respect to the backing material.

22. (canceled)

23. (canceled)

24. (canceled)

25. (canceled)

26. (canceled)

27. (canceled)

28. (canceled)

29. (canceled)

30. (canceled)
